(19) United States
(12) Patent Application Publication
(10) Pub. No.: US 2016/0176130 A1
(43) Pub. Date: Jun. 23, 2016

(54) METHOD OF FORMING A MICROLENS OVER AN OPTICAL ACTIVE DEVICE BY INJECTION PROCESS

(71) Applicant: Cosemi Technologies, Inc, Irvine, CA (US)

(72) Inventors: Haijiang Yu Yu, Irvine, CA (US); June Nguyen, Irvine, CA (US); Devang Parekh, Irvine, CA (US); Michael Cheng, Irvine, CA (US); Chien-Yu Kuo, Irvine, CA (US); Wenbin Jiang, Irvine, CA (US)

(21) Appl. No.: 14/578,451

(22) Filed: Dec. 21, 2014

(51) Int. Cl. B29D 11/00; G02B 13/14

(52) U.S. Cl. CPC B29D 11/00365; G02B 13/143; B29K 2105/0061

(57) ABSTRACT

Disclosed herein is a method of making an optical device, such as a photo diode or vertical cavity surface emitting laser (VCSEL). The method entails forming an active device within a substrate, forming a layer of surfactant over the active device; injecting microlens material over the surfactant layer directly above the active device, and curing the injected microlens material to form a microlens over the surfactant layer above the active device, such that the active device is capable of receiving or transmitting an optical signal by way of the microlens. An inkjet printing device may be used to inject the microlens material over the active device.

### FIELD

This disclosure relates generally to optical devices, such as photo detectors and vertical cavity surface emitting lasers (VCSELs), and in particular, to a method of forming a microlens over an optical active device by injection process.

### BACKGROUND

Optical devices are used to transmit and receive signals in the optical domain. Some optical devices, such as photo detectors, are used for receiving optical signals from external devices and converting them into electrical signals. Other optical devices, such as vertical cavity surface emitting lasers (VCSELs), are used for receiving electrical signals and converting them into optical signals for transmission to external devices.

The efficiency in coupling the optical signal from an external device to an optical device in the case of a photo detector depends on how much optical energy strikes the pn-junction of the photo detector. Similarly, the efficiency in coupling the optical signal from an optical device in the case of a VCSEL to an external device depends on how much optical energy is received by the external device.

To improve the coupling efficiency, small lenses, typically referred to as microlenses, may be formed over optical devices. In the case of photo detectors, microlenses are used to converge optical energy onto the pn-junction of the devices for improved optical coupling. In the case of VCSELs, microlenses are used to collimate the optical energy transmitted by VCSELs for improved coupling to external devices.

Conventionally, photo lithography is used as the primary technique for forming microlenses over optical devices. However, photo lithography has many disadvantages. Typically, a photo lithography process involves the deposition of lens forming material, thermal reflow of the material for improved uniformity, and a subsequent etching process. Accordingly, such process is relatively complex, increases the wafer processing time, and increases the costs of producing the wafers.

Thus, there is a need for an improved method of forming a microlens over an optical active device.

### SUMMARY

An aspect of the disclosure relates to a method of forming an optical device, such as a photo diode or a vertical cavity surface emitting laser (VCSEL). The method comprises forming an active device within a substrate, and injecting microlens material to form a microlens over the active device such that the active device is capable of receiving or transmitting an optical signal by way of the microlens.

In another aspect of the disclosure, the method further comprises forming a surfactant layer between the microlens and the active device. The surfactant layer may be formed over an aperture structure of the active device. In yet another aspect, the surfactant layer comprises a surfactant monolayer, such as perfluorooctyltrichlorosilane.

In another aspect of the disclosure, the microlens material comprises a hybrid polymer, such as sol-gel or epoxy resin. In another aspect, the method further comprises adding a solvent to the microlens material to achieve a defined viscosity for the microlens material. In yet another aspect, the method further comprises determining a volume of microlens material to inject to form the microlens.

In another aspect of the disclosure, the forming of the microlens further comprises curing the injected microlens material. In another aspect, the curing of the injected microlens comprises subjecting the injected microlens material to a first baking treatment, subjecting the injected microlens material to ultraviolet (UV) flood light exposure after the first baking treatment, and subjecting the injected microlens material to a second backing treatment after the UV flood light exposure. In yet another aspect, the first baking treatment comprises subjecting the injected microlens material to a temperature of 80 degrees Celsius for substantially 30 minutes. In still another aspect, the second baking treatment comprises subjecting the injected microlens material to a temperature of 150 degrees Celsius for substantially 25 minutes.

Other aspects, advantages and novel features of the present disclosure will become apparent from the following detailed description of the disclosure when considered in conjunction with the accompanying drawings.

### BRIEF DESCRIPTION OF THE DRAWINGS

FIG. 1A illustrates a side view of an exemplary optical device at a stage associated with an exemplary method of forming a microlens over an active device in accordance with an aspect of the disclosure.

FIG. 1B illustrates a side view of the exemplary optical device at a subsequent stage associated with the exemplary method of forming the microlens over the active device in accordance with another aspect of the disclosure.

FIG. 1C illustrates a side view of the exemplary optical device at another subsequent stage associated with the exemplary method of forming the microlens over the active device in accordance with another aspect of the disclosure.

FIG. 1D illustrates a side view of the exemplary optical device at yet another subsequent stage associated with the exemplary method of forming the microlens over the active device in accordance with another aspect of the disclosure.

FIG. 2 illustrates a side view of an exemplary optical receiving device receiving an optical signal from an external device in accordance with another aspect of the disclosure.

FIG. 3 illustrates a side view of an exemplary optical transmitting device transmitting an optical signal to an external device in accordance with another aspect of the disclosure.

FIG. 4A illustrates a side view of an exemplary optical device at a stage associated with another exemplary method of forming a microlens over an active device in accordance with another aspect of the disclosure.

FIG. 4B illustrates a side view of the exemplary optical device at a subsequent stage associated with the another exemplary method of forming the microlens over the active device in accordance with another aspect of the disclosure.

FIG. 4C illustrates a side view of the exemplary optical device at another subsequent stage associated with the another exemplary method of forming the microlens over the active device in accordance with another aspect of the disclosure.

FIG. 5 illustrates a side view of another exemplary optical device for transmitting or receiving an optical signal to or from an external device in accordance with another aspect of the disclosure.

### DETAILED DESCRIPTION OF THE EXEMPLARY EMBODIMENTS

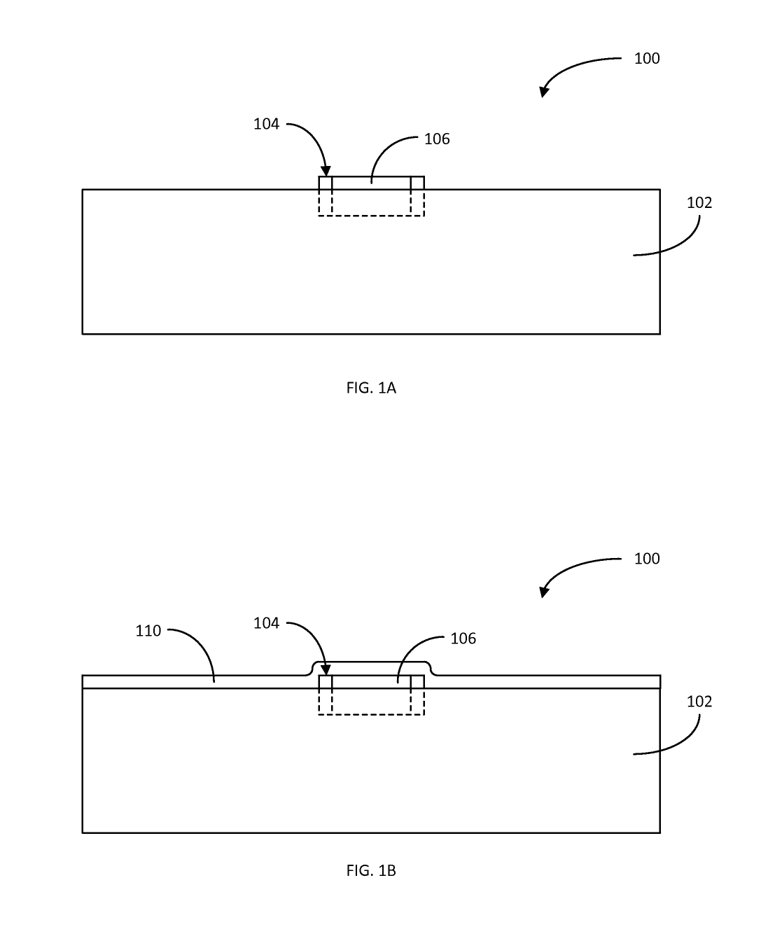

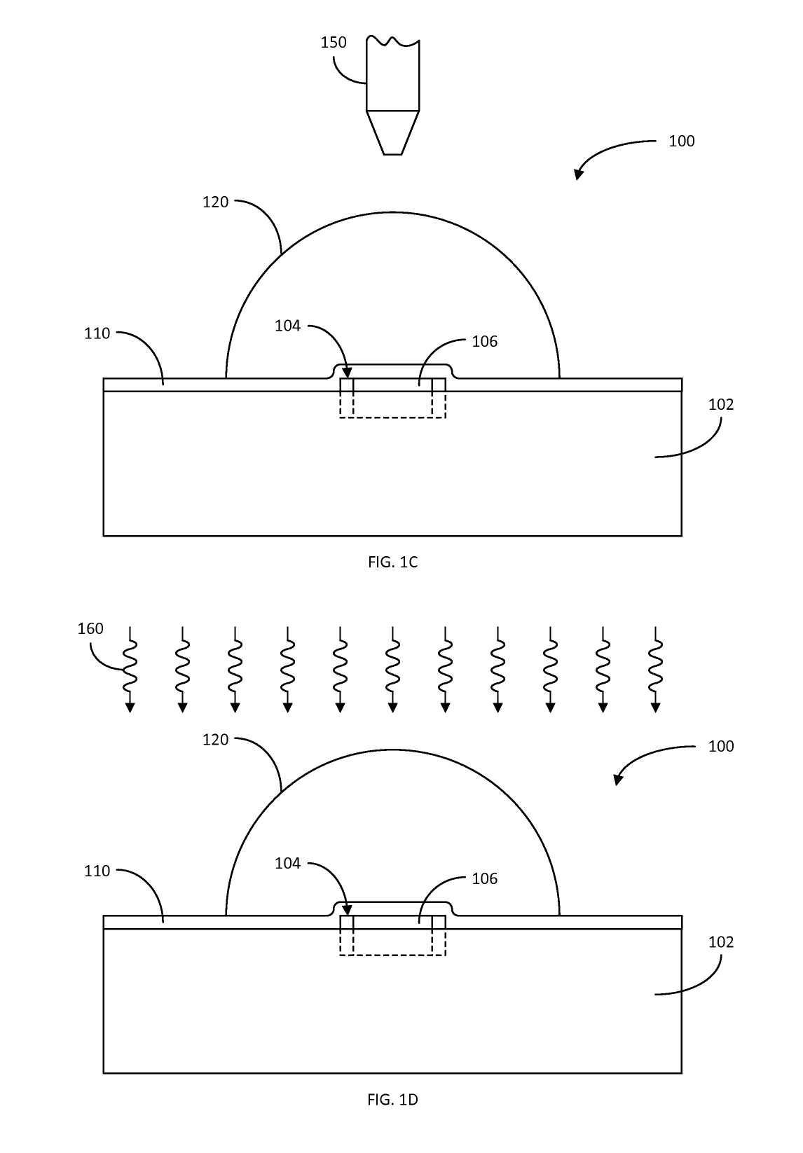

FIG. 1A illustrates a side view of an exemplary optical device 100 at a stage associated with an exemplary method of forming a microlens over an active device 104 in accordance with an aspect of the disclosure. At this stage, the active device 104 of the optical device 100 has been formed. The active device 104 may comprise a photo detector, a VCSEL, or another type of optical active device. In this example, the active device 104 is formed within and on a substrate or wafer 102, such as a semiconductor substrate or wafer (e.g., a GaAs semiconductor substrate or wafer). Additionally, in this example, the active device 104 comprises an aperture structure 106 to define a window through which optical signals are received or transmitted.

Although a single active device 104 is shown, it shall be understood that a plurality of active devices 104 may have been formed on the substrate or wafer 102. The substrate or wafer 102 including the active device 104 or a plurality of active devices may undergo a surface cleaning process to prepare it for subsequent processing as discussed as follows.

FIG. 1B illustrates a side view of the exemplary optical device 100 at a subsequent stage associated with the exemplary method of forming the microlens over the active device 104 in accordance with another aspect of the disclosure. According to the method, a layer of surfactant material 110 is deposited at least over the aperture structure 106 of the active device 104, and may be deposited substantially over the entire surface of the substrate or wafer 102. The surfactant material 110 is used to modify the surface energy of the substrate or wafer 102 to make the subsequently deposited microlens material to have the desired contact angle with the wafer surface to form the desired shape of the microlens. The surfactant material 110 may also assist in the adhesion of the microlens on the substrate or wafer 102. As an example, the surfactant material may be a surfactant monolayer, such as perfluorooctyltrichlorosilane, which can be used for the hydrophilic treatment of the surface of the substrate or wafer 102.

FIG. 1C illustrates a side view of the exemplary optical device 100 at another subsequent stage associated with the exemplary method of forming the microlens over the active device 104 in accordance with another aspect of the disclosure. According to the method, an injection tool 150 is positioned over the aperture structure 106 of the active device 104, and a microlens material 120 is injected over the surfactant-covered active device 104. The microlens material 120 may be a hybrid polymer, such as a sol-gel material or an epoxy resin based material whose viscosity can be tuned by solvent addition. The shape of the microlens 120 is formed primarily by surface tension.

The shape and size of the microlens 120 can be flexibly adjusted by the force of the injection, the volume of the droplet, and the type of surfactant monolayer 110. The injection tool 150 may be a commercialized inkjet type material printer which can achieve accurate positioning (e.g., accuracy of about one (1) micrometer (μm) or less) of defined microlens pattern on the substrate or wafer 102. The inkjet printer is operated to print or inject the microlens material over the active device to form the microlens. The injection force may be desirably set to generate a stable single droplet without causing splashed satellites. The droplet volume may be accurately controlled by a microelectromechanical system (MEMS) chip driven print head to achieve the specified size of the microlens 120.

FIG. 1D illustrates a side view of the exemplary optical device 100 at yet another subsequent stage associated with the exemplary method of forming the microlens over the active device 104 in accordance with another aspect of the disclosure. After the formation of the microlens droplet 120, the optical device 100 is subjected to a curing process. The curing process is performed to achieve the desired mechanical and optical properties of the microlens 120. As an example, the curing process may comprise subjecting the optical device 100 to a pre-baking treatment at, for example, 80 degrees Celsius for substantially 30 minutes (e.g., per the tolerances of the baking equipment). After the pre-backing treatment, the optical device 100 may be subjected to a LTV flood exposure 160 followed by a final baking treatment at, for example, 150 degrees Celsius for substantially 25 minutes (e.g., per the tolerances of the baking equipment). As a result of the curing process, the desired refractive index and optical transparency may be achieved for the microlens 120. As an example, the desired refractive index and optical transparency for wavelengths in the range of 800 to 1600 nanometers (nm) may be achieved by the aforementioned process.

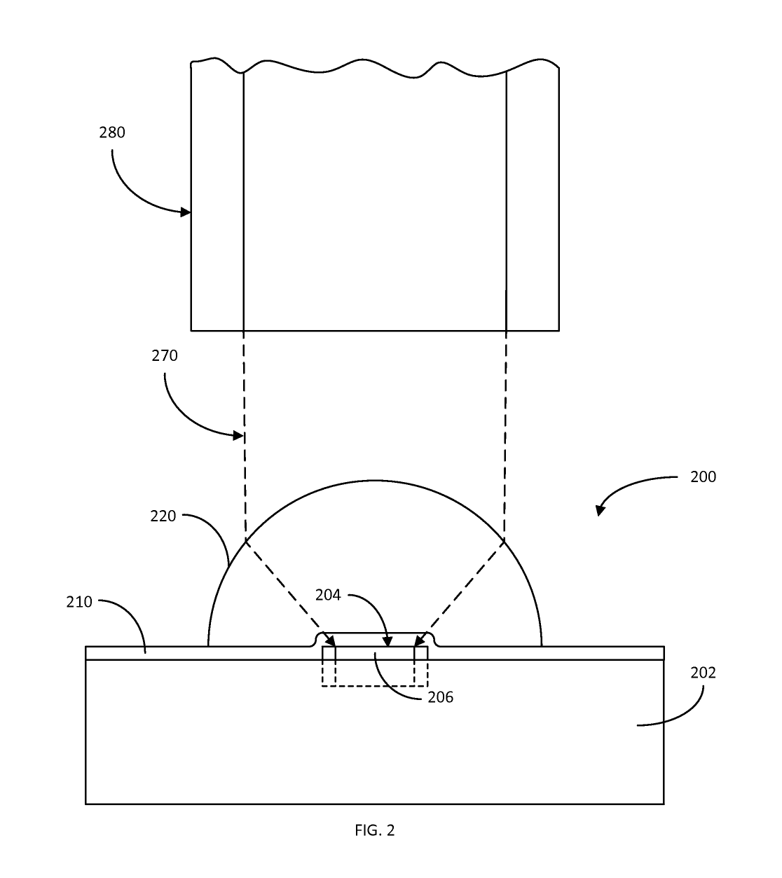

FIG. 2 illustrates a side view of an exemplary optical receiving device 200 receiving an optical signal 270 from an external device 280 in accordance with another aspect of the disclosure. The optical receiving device 200 comprises a substrate or wafer 202 including an active device 204 formed therein. In this example, the active device 204 may be a photo detector configured to receive the optical signal 270 by way of an aperture 206 and generate therefrom an electrical signal (not shown). The optical receiving device 200 further comprises a microlens 220 disposed over at least the aperture 206 of the active device 204. A layer of surfactant material 210 is situated between the microlens 220 and the active device 204. In this example, the external device 280 comprises an optical fiber configured to direct the optical signal 270 towards the optical receiving device 200. As shown, the microlens 220 converges the optical signal 270 substantially on the active device 204 by way of its aperture 206 in order to improve the coupling of the optical signal 270 from the optical fiber 280 to the active device 204.

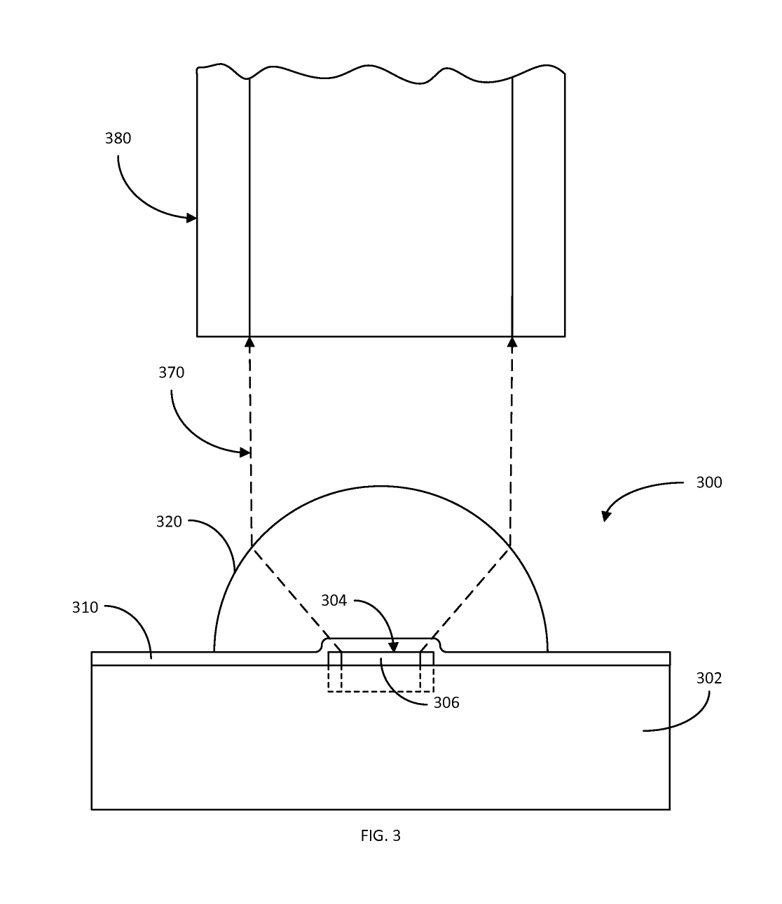

FIG. 3 illustrates a side view of an exemplary optical transmitting device 300 transmitting an optical signal 370 to an external device 380 in accordance with another aspect of the disclosure. The optical transmitting device 300 comprises a substrate or wafer 302 including an active device 304 formed therein. In this example, the active device 304 may be a VCSEL configured to generate and transmit the optical signal 370 by way of an aperture 306, from an input electrical signal (not shown). The optical transmitting device 300 further comprises a microlens 320 disposed at least over the aperture 306 of the active device 304. A layer of surfactant material 310 is situated between the microlens 320 and the active device 304. In this example, the external device 380 comprises an optical fiber configured to receive the optical signal 370 from the optical transmitting device 300. As shown, the microlens 320 collimate the optical signal 370 generated by the active device 304 in order to better direct the optical signal 370 towards a receiving end of the optical fiber 380. Accordingly, the microlens 320 substantially improves the coupling of the optical signal 370 from the active device 304 to the optical fiber 380.

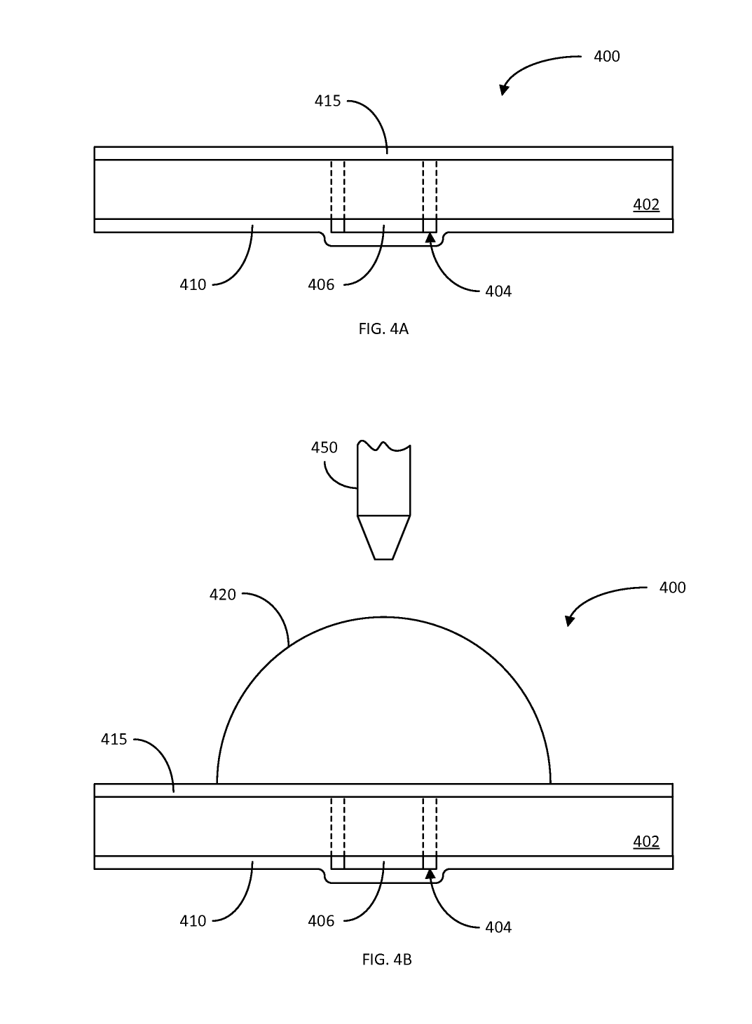

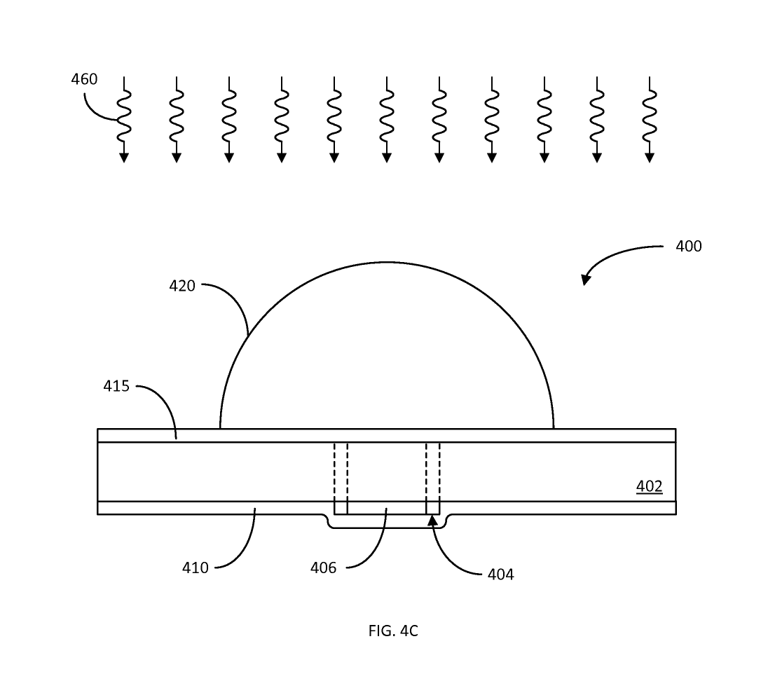

FIG. 4A illustrates a side view of an exemplary optical device 400 at a stage associated with another exemplary method of forming a microlens over an active device in accordance with another aspect of the disclosure. This method may be employed to form a microlens on a “bottom” side (e.g., the side opposite the aperture) of the active device. In FIGS. 4A-4C, the optical device 400 is illustrated in a “flipped” or up-side-down manner.

At this stage, the optical device 400 comprises a substrate or wafer 402 including an optical active device 404 formed therein. As in the previous embodiments, the optical active device 404 may be configured as a photo diode or VCSEL, and may include an aperture 406 formed on a “top” side of the substrate 402. The optical device 400 may also include a first surfactant layer 410 formed over the optical active device 404 including the aperture 406 on the “top” side of the substrate 402. According to the method, a second surfactant layer 415 may be formed over the optical active device 404 on the “bottom” side of the substrate 402. Similar to the previous embodiments, the first and second surfactant layers 410 and 415 may comprise a surfactant monolayer, such as perfluorooctyltrichlorosilane.

FIG. 4B illustrates a side view of the exemplary optical device 400 at a subsequent stage associated with the another exemplary method of forming the microlens over the active device in accordance with another aspect of the disclosure. According to the method, an injection tool 450 (e.g., an inkjet printer) may be operated to inject microlens material 420 over the optical active device 404 on the bottom side of the substrate 402. As in the previous embodiments, the microlens material 420 may comprise a hybrid polymer, such as a sol-gel material or an epoxy resin based material, whose viscosity can be tuned by solvent addition.

FIG. 4C illustrates a side view of the exemplary optical device 400 at another subsequent stage associated with the another exemplary method of forming the microlens over the active device in accordance with another aspect of the disclosure. After the formation of the microlens droplet 420, the optical device 400 may be subjected to a curing process. Similar to the previous embodiments, the curing process is performed to achieve desired mechanical and optical properties of the microlens 420. As in the previous example, the curing process may comprise subjecting the optical device 400 to a pre-baking treatment (e.g., 80 degrees Celsius for substantially 30 minutes), followed by a UV flood exposure 460, then a final baking treatment (e.g., 150 degrees Celsius for substantially 25 minutes). As a result of the curing process, the desired refractive index and optical transparency may be achieved for the microlens 420. As in the previous embodiments, the desired refractive index and optical transparency for wavelengths in the range of 800 to 1600 nanometers (nm) may be achieved by the aforementioned process.

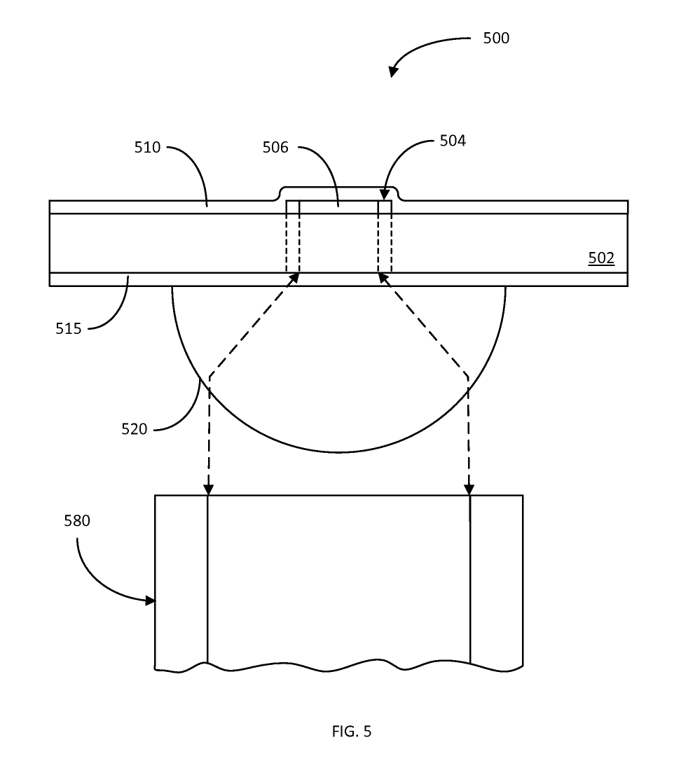

FIG. 5 illustrates a side view of another exemplary optical device 500 for transmitting or receiving an optical signal to or from an external device in accordance with another aspect of the disclosure. The optical device 500 may be formed using the method of making the optical device 400 previously discussed.

In particular, the optical device 500 comprises a substrate or wafer 502 including an optical active device 504 extending from a top side to a bottom side of the substrate 502. The optical active device 504 may include an aperture structure 506 formed on the top side of the substrate 502. The optical device 500 may include a first layer of surfactant 510 formed over the optical active device 504 including the aperture structure 506 at the top side of the substrate 502. The optical device 500 may also include a second layer of surfactant layer 515 disposed over the optical active device 504 on the bottom side of the substrate 502.

The optical device 500 may transmit or receive an optical signal to or from an external device 580, such as an optical fiber. In this example, the optical device 500 transmits or receives an optical signal by way of the “bottom” side of the substrate 502; and may, in particular, by way of the second surfactant layer 515.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of making an optical device, comprising:
forming an active device within a substrate; and
injecting microlens material to form a microlens over the active device such that the active device is capable of receiving or transmitting an optical signal by way of the microlens.

2. The method of claim 1, wherein injecting microlens material comprises operating an inkjet printer to inject the microlens material.

3. The method of claim 1, wherein the active device comprises a photo diode.

4. The method of claim 1, wherein the active device comprises a vertical cavity surface emitting laser (VCSEL).

5. The method of claim 1, further comprising forming a surfactant layer between the microlens and the active device.

6. The method of claim 5, wherein the surfactant layer is formed over an aperture structure of the active device.

7. The method of claim 5, wherein the surfactant layer comprises a surfactant monolayer.

8. The method of claim 5, wherein the surfactant layer comprises perfluorooctyltrichlorosilane.

9. The method of claim 1, wherein the microlens material comprises a hybrid polymer.

10. The method of claim 1, wherein the microlens material comprises a sol-gel material.

11. The method of claim 1, wherein the microlens material comprises an epoxy resin.

12. The method of claim 1, further comprising adding a solvent to the microlens material to achieve a defined viscosity for the microlens material.

13. The method of claim 1, further comprising determining a volume of microlens material to inject to form the microlens.

14. The method of claim 1, wherein forming the microlens comprises curing the injected microlens material.

15. The method of claim 14, wherein curing the injected microlens material comprises:
subjecting the injected microlens material to a first baking treatment;
subjecting the injected microlens material to an ultraviolet (UV) flood light exposure after the first baking treatment; and
subjecting the injected microlens material to a second backing treatment after the UV flood light exposure.

16. The method of claim 15, wherein the first baking treatment comprises subjecting the injected microlens material to a temperature of 80 degrees Celsius for substantially 30 minutes.

17. The method of claim 15, wherein the second baking treatment comprises subjecting the injected microlens material to a temperature of 150 degrees Celsius for substantially 25 minutes.

18. A method of making an optical device, comprising:
forming an active device within a substrate;
forming a layer of surfactant over the active device;
injecting microlens material over the surfactant layer above the active device; and
curing the injected microlens material to form a microlens over the surfactant layer above the active device such that the active device is capable of receiving or transmitting an optical signal by way of the microlens.

19. The method of claim 18, wherein:
the surfactant layer comprises perfluorooctyltrichlorosilane; and
the microlens material comprises a hybrid polymer.

20. The method of claim 18, wherein injecting microlens material comprises operating an inkjet printer to inject the microlens material.

21. The method of claim 18, wherein the surfactant layer is formed over an aperture structure of the active device.

22. An optical device, comprising:
an active device formed within a substrate;
a layer of surfactant disposed over the active device; and
a microlens disposed over the surfactant layer and the active device such that the active device is capable of receiving or transmitting an optical signal by way of the microlens.

23. The optical device of claim 22, wherein the surfactant layer is formed over an aperture structure of the active device.
